(19) United States
(12) Patent Application Publication
(10) Pub. No.: US 2002/0098774 A1
(43) Pub. Date: Jul. 25, 2002

(54) Geometric construction system

(76) Inventor: Te-Li Huang, Taichung City (TW)

Correspondence Address: LADAS & PARRY, 224 SOUTH MICHIGAN AVENUE, SUITE 1200, CHICAGO, IL, 60604, US

(21) Appl. No.: 09/767,102

(22) Filed: Jan. 22, 2001

(51) Int. Cl. A63H 33/00; G09B 1/06; G09B 19/02

(52) U.S. Cl. 446/487; 446/104; 446/109; 446/111; 434/159; 434/167; 434/191

(57) ABSTRACT

A geometric construction system includes at least two panels which are sidewisely and pivotally coupled together. Each of the panels has a plurality of side edges, a central opening confined by the side edges, a supporting plate received in the central opening, and a plurality of retaining plates laterally protruding from inner walls of the side edges into the central opening and cooperating with the supporting plate so as to form a plurality of retaining slots. Flexible patterned sheets are received in the central openings in the two panels. Each sheet has engaging portions respectively extending into and engaging releasably the retaining slots so as to be detachably retained in the central opening in the respective one of the panels.

### BACKGROUND OF THE INVENTION

1. Field of the Invention

This invention relates to a geometric construction system, more particularly to a geometric construction system including a plurality of flat panels with patterned sheets attached thereon.

2. Description of the Related Art

A geometric construction system normally includes a plurality of panels of polygonal shape, which can be sidewisely coupled together to form two- and three-dimensional arrays. The panels are usually patterned on the side faces for educational or amusement purposes. However, processing of the patterns on the panels is both inconvenient and costly. Moreover, the design of the geometric construction system is disadvantageous in that each two adjacent coupled panels cannot overlap with each other.

### SUMMARY OF THE INVENTION

Therefore, it is an object of the present invention to provide a geometric construction system that is capable of overcoming the aforementioned drawbacks.

Accordingly, a geometric construction system of this invention comprises: at least two substantially flat panels of equilateral polygonal shape, which are sidewisely and pivotally coupled together so as to be turnable relative to each other, each of the panels having a plurality of side edges that have top and bottom ends and inner walls, a central opening confined by the inner walls of the side edges, a supporting plate received in the central opening between the top and bottom ends of the side edges and extending between and interconnecting the inner walls, and a plurality of spaced apart retaining plates laterally protruding from the top ends of the inner walls into the central opening and cooperating with the supporting plate so as to form a plurality of retaining slots therebetween; and at least two flexible patterned sheets, each of which is received in the central opening in a respective one of the panels and each of which has engaging portions respectively extending into and engaging releasably the retaining slots so as to be detachably retained in the central opening in the respective one of the panels.

### BRIEF DESCRIPTION OF THE DRAWINGS

In drawings which illustrate an embodiment of the invention,

FIG. 1 is a perspective view of a geometric construction system embodying this invention, with three panels coupled together;

FIG. 2 is a cross-sectional side view of one of the panels of the geometric construction system taken along line II-II of FIG. 1;

FIG. 3 is a partly cross-sectional side view of the panel of FIG. 2, with a patterned sheet attached thereto;

FIG. 4 is a top view of one of the panels of the geometric construction system of FIG. 1;

FIGS. 5 to 8 are views to illustrate that the geometric construction system of this invention can be constructed into different configurations and with different patterns on the panels; and

FIG. 9 is an exploded view to illustrate two of the panels coupled by a connecting rod of the geometric construction system of FIG. 1.

### DETAILED DESCRIPTION OF THE PREFERRED EMBODIMENT

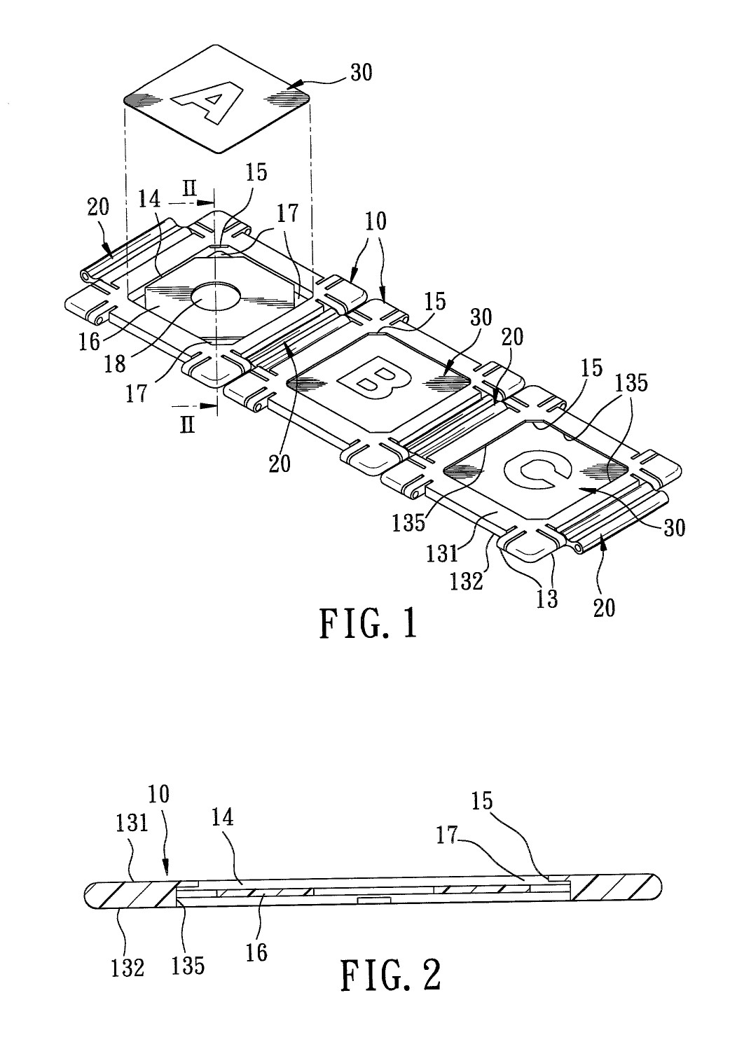

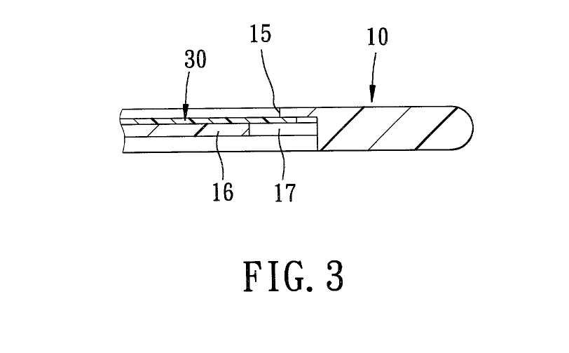

FIGS. 1 to 4 illustrate a preferred embodiment of a geometric construction system of this invention. The geometric construction system includes: a plurality of substantially flat panels 10 of generally square shape (only three panels 10 are shown), which are sidewisely and pivotally coupled together via connecting rods 20 so as to be turnable relative to each other, each of the panels 10 having side edges 13 that respectively have top and bottom ends 131, 132 and inner walls 135, a central opening 14 confined by the inner walls 135 of the side edges 13, a supporting plate 16 received in the central opening 14 between the top and bottom ends 131, 132 of the side edges 13 and extending between and interconnecting the inner walls 135, and a plurality of spaced apart retaining plates 15 laterally protruding from the top ends 131 of the inner walls 135 at corners of the latter into the central opening 14 and cooperating with the supporting plate 16 so as to form a plurality of retaining slots 17 therebetween; and a plurality of flexible patterned sheets 30 (only three sheets 30 are shown) of generally square shape, each of which has a shape conforming to and is received in the central opening 14 in a respective one of the panels 10 and each of which has engaging portions, i.e. the portions at the corners thereof, respectively extending into and engaging releasably the retaining slots 17 so as to be detachably retained in the central opening 14 in the respective one of the panels 10. Preferably, each retaining plate 15 is not superimposed on the respective supporting plate 16 so as to facilitate mounting and dismounting of the patterned sheet 30 thereon.

A central aperture 18 is formed in each supporting plate 16 so as to permit access to and thus facilitate dismounting of a respective one of the patterned sheets 30.

With the patterned sheets 30 and the retaining slots 17, the inconvenient and costly drawbacks as encountered in the prior art can be overcome. Moreover, the detachability of the patterned sheets 30 permits the geometric construction system of this invention to have a wide variety of configurations and pattern arrays for play.

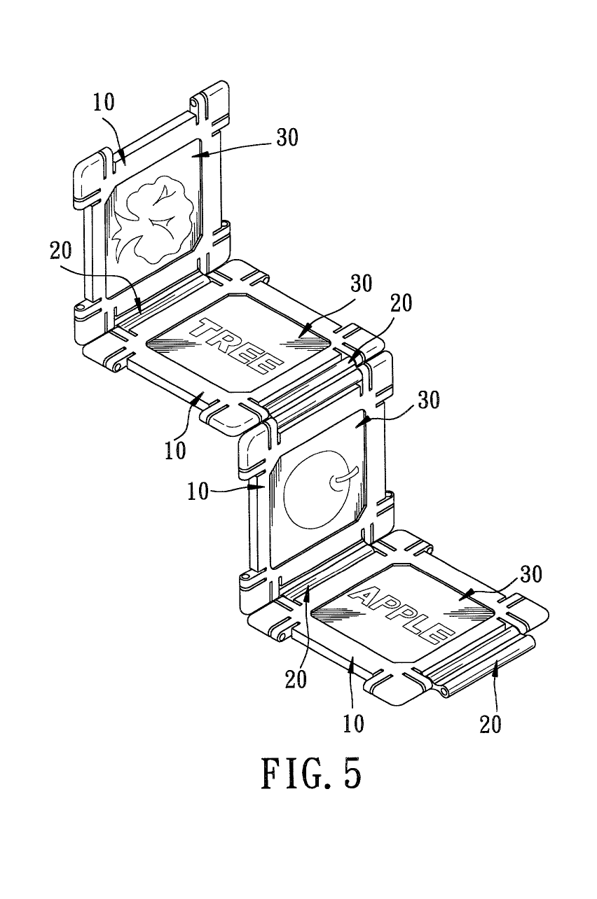

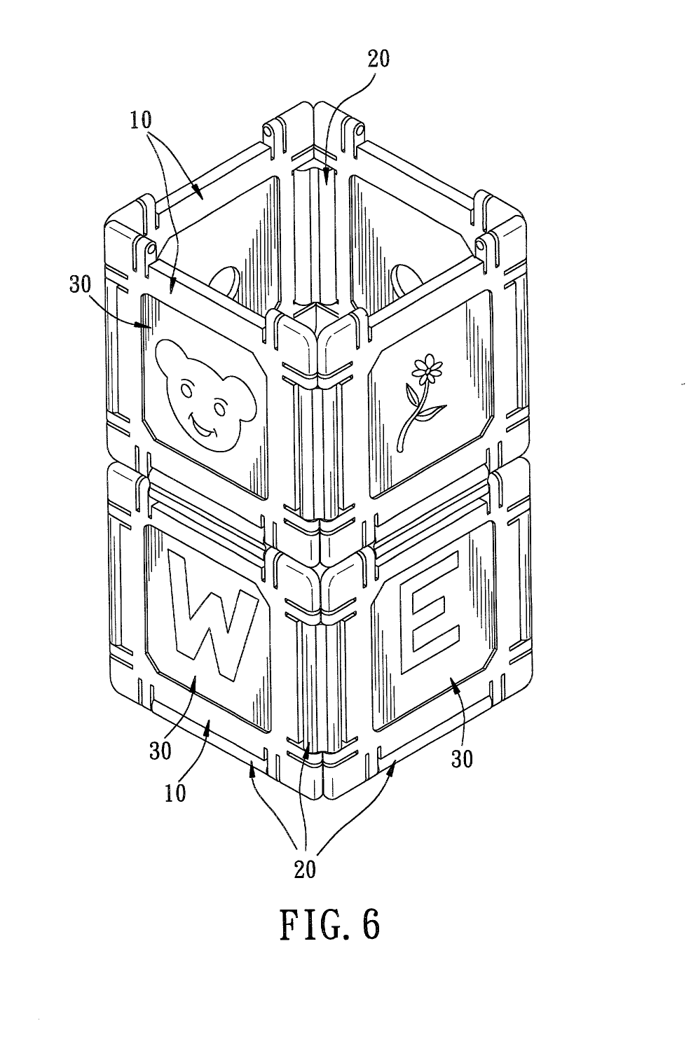

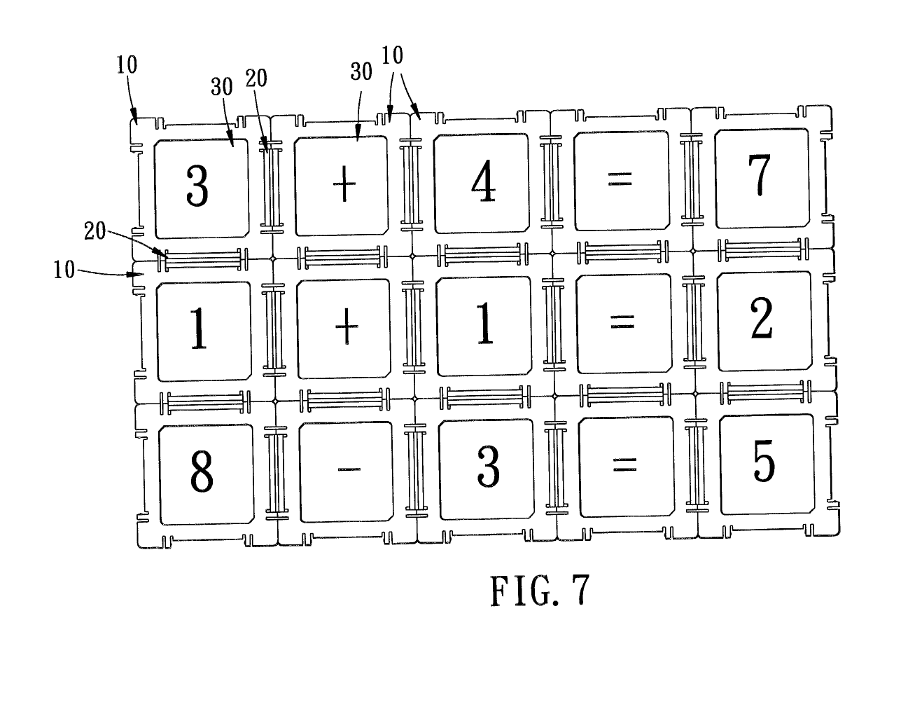

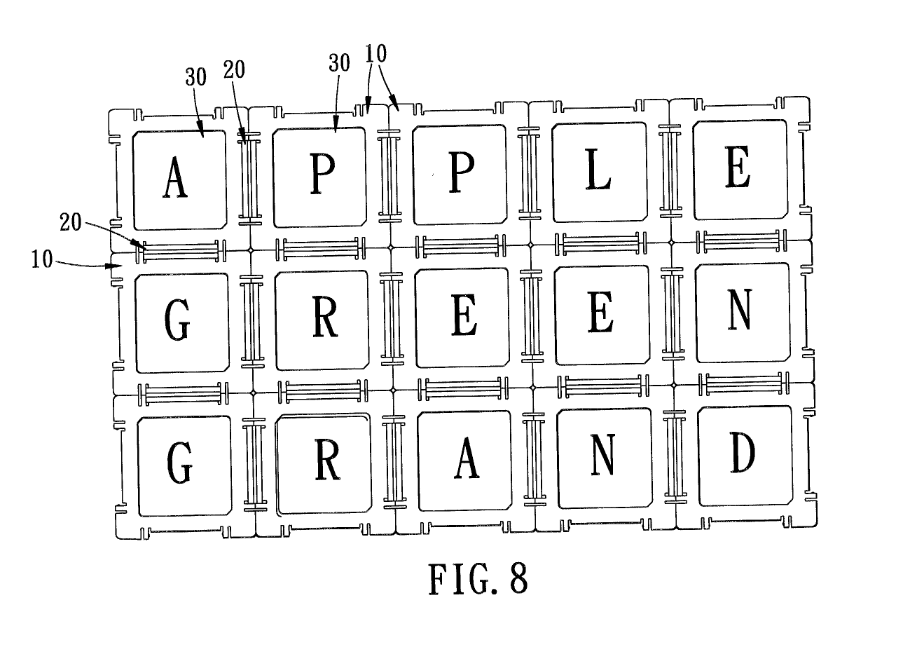

FIGS. 5 to 8 illustrate exemplary configurations and different patterns on the panels 10, that can be constructed using the geometric construction system of this invention.

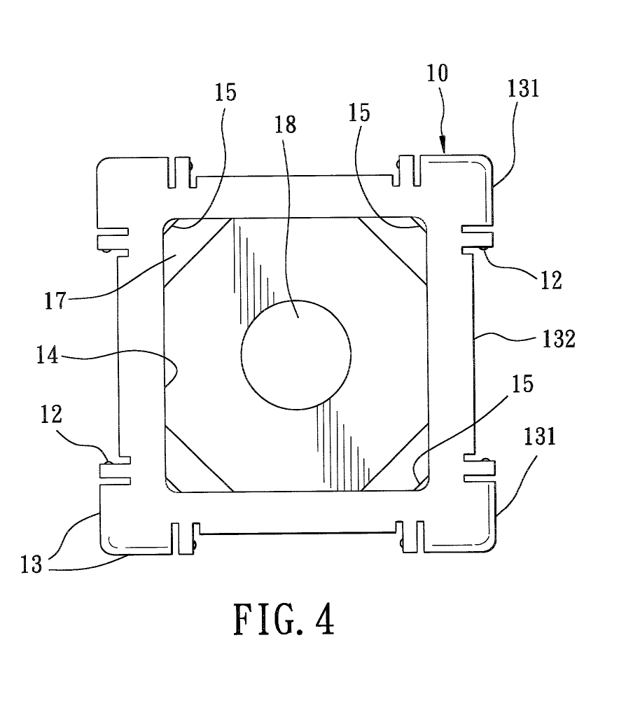

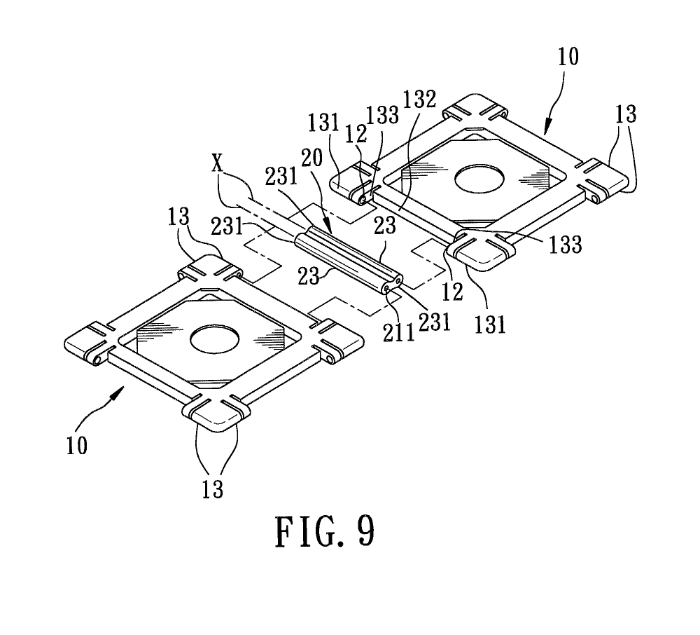

Referring to FIG. 9, in combination with FIGS. 1 and 4, each of the side edges 13 has two opposite end sections 131 and a basin section 132 that extends between and inwardly relative to the end sections 131 and that has two opposite end faces 133 respectively transverse to the end sections 131. Each connecting rod 20 has a generally elliptical cross-section, and has two interconnected connecting portions 23, each of which extends in a longitudinal direction and each of which is complementary to and is received in the basin section 132 of one of the side edges 13 of one of the panels 10. Each of the connecting portions 23 has two opposite ends 231 respectively pivoted on the end faces 133 of the basin section 132 of one of the side edges 13 of the respective one of the panels 10 so as to permit each of the panels 10 to be freely turnable about an axis (X) that is defined by the respective connecting portion 23 and that extends through the opposite ends 231 of the respective one of the connecting portions 23 of the connecting rod 20 in the longitudinal direction.

Each of the end faces 133 of the basin section 132 of each of the side edges 13 is formed with a boss 12 projecting therefrom and transverse thereto. Each of the ends 231 of each of the connecting portions 23 of the connecting rod 20 is formed with a recess 211 that fittingly receives the boss 12 on the respective one of the end faces 133 SO as to permit rotation of each of the panels 10 about the respective axis (X). It is apparent to a person skilled in the art that each of the end faces 133 of the basin section 132 can be formed with the recess 211 instead of the boss 12, and that each of the ends 231 of each of the connecting portions 23 can be formed with the boss 12 instead of the recess 211. Alternatively, one of the end faces 133 of the basin section 132 can be formed with the boss 12 and the other one can be formed with the recess 211, whereas one of the ends 231 of each of the connecting portions 23 can be formed with the boss 12 and the other one can be formed with the recess 211.

With the connecting rod 20 being formed with the recesses 211 in each end 231 of each connecting portion 23, and with the end faces 133 of the basin section 132 of each side edge 13 being formed with the bosses 12, each coupled panel 10 is permitted to be freely rotated about the respective axis (X) toward and away from an adjacent panel 10, and the coupled panels 10 are permitted to be evenly stacked one above the other.

With the invention thus explained, it is apparent that various modifications and variations can be made without departing from the spirit of the present invention. It is therefore intended that the invention be limited only as recited in the appended claims.

I claim:

1. A geometric construction system comprising:
at least two substantially flat panels of equilateral polygonal shape, which are sidewisely and pivotally coupled together so as to be turnable relative to each other, each of said panels having a plurality of side edges that have top and bottom ends and inner walls, a central opening confined by said inner walls of said side edges, a supporting plate received in said central opening between said top and bottom ends of said side edges and extending between and interconnecting said inner walls, and a plurality of spaced apart retaining plates laterally protruding from said top ends of said inner walls into said central opening and cooperating with said supporting plate so as to form a plurality of retaining slots therebetween; and
at least two flexible patterned sheets, each of which is received in said central opening in a respective one of said panels and each of which has engaging portions respectively extending into and engaging releasably said retaining slots so as to be detachably retained in said central opening in the respective one of said panels.

2. The geometric construction system of claim 1, wherein said supporting plate has a central aperture formed therein so as to permit access to a respective one of said patterned sheets.

3. The geometric construction system of claim 1, wherein each of said side edges has two opposite end sections and a basin section that extends between and inwardly relative to said end sections and that has two opposite end faces respectively transverse to said end sections, said geometric construction system further comprising at least a connecting rod having at least two interconnected connecting portions, each of which extends in a longitudinal direction and each of which is complementary to and is received in said basin section of one of said side edges of one of said panels, each of said connecting portions having two opposite ends respectively pivoted on said end faces of said basin section of said one of said side edges of the respective one of said panels so as to permit each of said panels to be freely turnable about an axis that extends through said opposite ends of the respective one of said connecting portions of said connecting rod in the longitudinal direction.

4. The geometric construction system of claim 3, wherein each of said end faces of said basin section of each of said side edges is formed with a boss projecting therefrom and transverse thereto, and each of said ends of each of said connecting portions of said connecting rod is formed with a recess that fittingly receives said boss on the respective one of said end faces so as to permit rotation of each of said panels about said axis.

5. The geometric construction system of claim 3, wherein each of said ends of each of said connecting portions of said connecting rod is formed with a boss projecting therefrom, and each of said end faces of said basin section of each of said side edges is formed with a recess that fittingly receives said boss on the respective one of said ends of the respective one of said connecting portions of said connecting rod so as to permit rotation of each of said panels about said axis.
